(19) United States
(12) Patent Application Publication
(10) Pub. No.: US 2008/0066606 A1
(43) Pub. Date: Mar. 20, 2008

(54) Oboe and Oboe Head

(76) Inventor: Michel Croquenoy, Cravent (FR)

Correspondence Address: BROWDY AND NEIMARK, P.L.L.C.;624 NINTH STREET, NW, SUITE 300, WASHINGTON, DC, 20001-5303, US

(21) Appl. No.: 10/583,871

(22) PCT Filed: Mar. 15, 2005
(86) PCT No.: PCT/FR05/00619

§ 371 Date: Jun. 21, 2006

(30) Foreign Application Priority Data
Mar. 22, 2004 (FR) 0402918

(51) Int. Cl. G10D 7/06

(52) U.S. Cl. 84/380 R

(57) ABSTRACT

An oboe comprising an elongate body in two parts which can fit inside each other, wherein one first part (10) is provided with a place (11) for putting the reed at one end thereof (10a) which is adapted in order to receive said reed and a second part (20) which is adapted in order to be fitted to a bell (30). The transversal plane of fitment of said two parts (10, 20) of the body is located between the octave holes (13) and the note holes, wherein the note holes are positioned exclusively in the second part (20) and the bell (30).

The present invention concerns a wind instrument such as an oboe.

It also concerns an oboe head adapted to be mounted on a body portion of the oboe of the invention.

Oboes are wind instruments generally comprising three portions that nest one inside the other.

Thus an oboe comprises an elongate body in two portions that can be nested one in the other. A first portion, carrying at one end an “onion” adapted to receive a reed, is called the top body. A second portion of the body, called the bottom body, is adapted to be nested over a horn constituting a third portion of the oboe.

The various portions of the body and the horn are pierced with holes, opening or closing which modifies in particular the pitch of the sound emitted by the instrument.

These holes are traditionally stopped by pads covered with cork or felt operated by means of a series of keys via links extending between the keys and the pads.

An oboe traditionally comprises a series of openings extending from its onion to its horn, and in particular octave holes, trill holes (also known as cadence holes) and note holes spreading over more than one octave between low B flat and C sharp or open medium D flat.

In a traditional oboe, the top body includes the octave holes, the trill holes and the note holes between C sharp and G sharp.

The bottom body includes note holes between G and C, while the horn includes the B natural hole and a hole for modifying the resonance of the horn. The low B flat is obtained by closing B natural with all notes blocked.

This type of wind instrument is still traditionally made of wood, generally of ebony, for the qualities of sound it procures.

However, an instrument of this kind is very fragile, and it is not rare for the body of the oboe, and more particularly the top body of the oboe, to split through contact with moisture present in the breath of the player and in the event of thermal shock.

Moreover, fitting the top body and the bottom body together is not always facilitated by the presence of keys and links that project beyond each body.

An object of the present invention is to solve the problems cited above and to propose an oboe that is more ergonomic for the player to assemble and play.

To this end, the present invention is directed to an oboe comprising an elongate body in two portions adapted to be nested one in the other, a first portion carrying at one end a onion adapted to receive a reed and a second portion being adapted to be nested with a horn.

According to the invention, a plane of transverse nesting of the two portions of the body is situated between octave holes and note holes, there being note holes only in said second portion and the horn.

The oboe of the invention therefore has a new arrangement of the body and is no longer divided in the traditional way into upper and lower portions, of substantially equal length, but rather consists of a main body on which is mounted an oboe head that comprises octave holes in the vicinity of the onion and where appropriate trill holes disposed between the octave holes and the note holes.

Among other things, this new position of the plane of transverse nesting of the two portions of the body allows modification of the positioning of the notes along the body of the oboe and in particular makes it possible to move closer together certain notes that are traditionally far apart because of the presence of the necessary fixing means between the two body portions of a traditional oboe.

Moreover, the oboe has a readily interchangeable head, enabling adaptation of the range and a specific sound to be achieved for each oboe simply by changing the head.

Moreover, should the oboe head split, it can more easily be changed and replaced by fitting a new head to the main body of the oboe.

According to one preferred feature of the invention, the transverse nesting plane is situated between the octave holes and trill holes disposed between said octave holes and the note holes.

In other words, the first portion of the body of the oboe comprises only octave holes.

According to another preferred feature of the invention, the G sharp key extends partly under the E flat key.

This disposition of the keys traditionally situated between the A and G holes is made possible by the absence of a nesting plane in this portion of the body of the oboe.

It makes on passing from one key to another more ergonomic for the player.

An oboe of the invention advantageously comprises an accessory in the form of another first portion interchangeable with said first portion, so that the player can modify the sound and the tonality of the instrument.

A second aspect of the invention consists in an oboe head including octave holes and carrying at one end a onion adapted to receive a reed, characterized in that it is adapted to be nested over a second body portion of an oboe according to the first aspect of the invention.

Other features and advantages of the invention will become further apparent in the course of the following description.

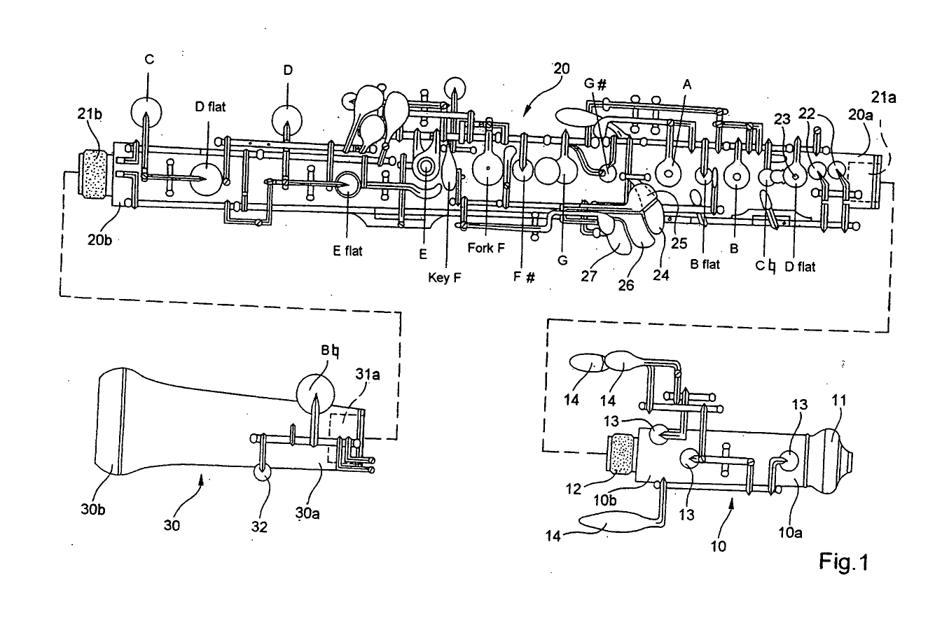

In the appended drawing, which is provided by way of nonlimiting example, FIG. 1 shows one embodiment of an oboe of the invention when taken apart.

An oboe of the invention is described next with reference to FIG. 1.

The oboe comprises three portions:

a body portion 10 carrying at one end a onion 11, this portion being referred to in the remainder of the description as the head 10 of the oboe;

a second portion 20 adapted to be fitted at a first end 20a to the head 10 of the oboe; and

a horn 30 adapted to be fitted to a second end 20b of the body 20 of the oboe.

These portions 10, 20, 30 of the oboe of the invention are described in detail next.

Thus the first portion 10 has at one end 10a a onion 11 adapted to receive a reed (not shown).

The oboe head 10 has at a second lengthwise end 10b fixing means 12 adapted to enable the head 10 to nest inside the body 20 of the oboe.

In this embodiment, the fixing means 12 constitute a tenon projecting beyond the head 10.

The oboe head may have a length from 100 to 120 mm and preferably has a length of 102 mm excluding the projecting fixing means 12.

The oboe head 10 is therefore very much shorter than the usual top body of a traditional oboe, the length of which is substantially 233 mm.

Thus this embodiment of the oboe head 10 comprises only the octave holes 13, of which there are three. It also supports the links and the respective keys 14 associated with each of the octave holes 13.

The main body 20 of the oboe also includes fixing means 21a, 21b disposed at its ends 20a, 20b, respectively.

The end 20a of the body 20 being adapted to cooperate nesting fashion with the head 10 of the oboe, the fixing means 21a take the form of a mortice 21a with dimensions complementary to those of the tenon 12.

Conversely, the second end 20b of the body 20 includes fixing means 21b consisting of a tenon similar to the tenon 12 on the head 10 of the oboe.

The length of the oboe body 20 excluding the fixing means 21b projecting at one end 20b of the body 20 is from 365 to 375 mm.

In the embodiment described, the oboe head having a length of 102 mm, the body 20 preferably has a length of 370 mm.

Thus this body portion 20 of the oboe has a length much greater than the standard length of the bottom body of a traditional oboe, which is about 238 mm.

The body 20 of the oboe includes from the top downwards (i.e. from the right toward the left in the figure) trill holes (also called cadence holes) 22 and a top plate 23 (for the “half hole”) corresponding to the octave of the notes E flat, D and D flat, associated with the D flat (or open C sharp) plate.

The body 20 of the oboe is therefore pierced by a succession of holes corresponding to the notes C natural, B, B flat, A, G sharp, G, F sharp, F, E, E flat, D, D flat and C. There are two F notes respectively called fork F and key F.

The body 20 of the oboe also includes in the traditional way the links and keys associated with each of the note holes for opening and closing the hole.

In particular, it includes a key 24, called the G sharp key, and keys 25, 26, 27, respectively called the E flat, B natural and B flat keys, known as the “feather keys”.

The second end 20b of this portion 20 of the oboe body is intended to be attached to the horn 30, which has at one end 30a complementary fixing means 31a, here consisting of a mortice 31a adapted to cooperate with the tenon 21b on the body 20.

The other end 30b of the horn forms an opening discharging to the open air, adapted to enable the oboe to resonate, the low B flat sounding via this opening.

The length of the horn is substantially 128 mm and corresponds to the length of the horn of a traditional oboe.

The instrument as a whole, when assembled, has a length from the onion 11 to the end 30b of the horn of substantially 600 mm.

The horn 30 traditionally includes a hole for the note B natural and a hole 32 for modifying the resonance of the horn.

Thus the oboe of the invention has a nesting plane between the head 10 and the body 20 situated between the octave holes 13 and the note holes, and in this embodiment between the octave holes 13 and the trill holes 22 near the end 20a of the body 20 of the oboe.

This new arrangement eliminates the nesting plane in the body of a traditional oboe substantially between the G sharp and G holes.

This new location of the nesting plane produces a more homogeneous body 20, in particular as regards the longitudinal bore of the body, as there is no longer any difference in inside diameter between the different bodies as is caused by nesting the top body and the bottom body in a traditional oboe, which therefore eliminates all risk of offsetting or eccentricity inside the main body of the oboe.

The body 20 being in one piece, the positioning of the note holes on the instrument can be improved and in particular the note holes can be distributed better.

The system of links and associated keys can therefore be made more logical.

In particular, it is possible to move the A, G sharp and G holes closer together as there is no longer a tenon in this portion of the body 20.

In practice, it is possible to raise the G hole approximately 3 mm in the direction of the onion 11 of the oboe and in contrast to lower the G sharp, A, B flat, B and C holes about 2 mm in the direction of the horn 30. Thus the distance between the G and G sharp holes can be reduced by approximately 5 mm compared to a traditional oboe.

It is also possible to lower the medium D flat plate approximately 5 mm, the top plate 23 also serving as an octave key for the low E flat, low D and low D flat notes.

Moving this octave key 23 closer to the fundamental note substantially improves the passage to the octave of these fundamental notes, in particular for the note D flat, considered the most delicate note of the instrument.

Moreover, by eliminating the nesting plane at the level of the G sharp hole and the feather keys 24-27, it is possible to obtain a more ergonomic mechanical arrangement by modifying the disposition of the feather keys. In particular, as shown clearly in the figure, the G sharp key 24 lies partly under the E flat key 25.

This type of assembly, which is virtually impossible in a traditional oboe in which the nesting plane is at the level of the feather keys, allows the keys to be positioned in a manner facilitating the task of the player.

Furthermore, the head 10 of the oboe has the advantage that it can be changed easily, whether to modify the sound and playing of the instrument or to change it in the event of a split in the wood.

In fact, this head portion 10 is crucial to the sound, accuracy and octave notes of the instrument and it may be beneficial for the oboe to include one or more interchangeable heads as accessories.

For example, the oboe heads 10 could have different longitudinal bore diameters, and where appropriate different lengths.

It is furthermore possible to use a head made from a material that is insensitive to thermal shock and moisture, for example resin, plastic or Altuglass® type polymethylmethacrylate.

A material that is insensitive to thermal shock and moisture improves the resistance of the oboe head to splitting, which can occur because of moisture in the breath of the player and in the event of concerts in cold places (churches, air-conditioned premises, etc.).

Thus each player can personalize the instrument by choosing an appropriate oboe head 10.

Of course, many modifications may be made to the above embodiment without departing from the scope of the invention.

Thus an embodiment has been described in which the nesting plane of the head 10 and the main body 20 of the oboe is situated between the octave holes 13 and the trill holes 22.

It could nevertheless be envisaged, in the context of the invention, that the nesting plane be situated between the trill holes 22 and the note holes, for example between the trill holes 22 and the open medium D flat hole.

Furthermore, an oboe pitched in C has been described with reference to FIG. 1.

The present invention could equally find an application to other types of instrument, such as the musette (also called an oboe musette or piccolo oboe) pitched in E flat, the oboe d'amore pitched in A, the baritone oboe pitched in C or the cor anglais pitched in F.

1. Oboe comprising an elongate body in two portions adapted to be nested one in the other, a first portion (10) carrying at one end (10a) a onion (11) adapted to receive a reed and a second portion (20) being adapted to be nested with a horn (30), characterized in that a plane of transverse nesting of the two portions of the body is situated between octave holes (13) and note holes, there being note holes only in said second portion (20) and the horn (30).

2. Oboe according to claim 1, characterized in that said transverse nesting plane is situated between the octave holes (13) and trill holes (22) disposed between said octave holes (13) and the note holes.

3. Oboe according to claim 2, characterized in that the first body portion (10) includes only octave holes (13).

4. Oboe according to any one of claims 1 to 3, characterized in that the G sharp key (24) extends partly under the E flat key (25).

5. Oboe according to claim 1, characterized in that the first body portion (10) carrying the octave holes (13) has a length from 100 to 120 mm.

6. Oboe according to claim 5, characterized in that said first body portion (10) has a length of substantially 102 mm.

7. Oboe according to claim 1, characterized in that the second body portion (20) carrying the note holes has a length of substantially 370 mm.

8. Oboe according to claim 1, characterized in that it comprises an accessory in the form of another first portion interchangeable with said first portion (10).

9. Oboe head including octave holes (13) and carrying at one end (10a) a onion (11) adapted to receive a reed, characterized in that it is adapted to be nested with a second body portion (20) of an oboe according to claim 1.

10. Oboe head according to claim 9, characterized in that it has a length from 100 to 120 mm.

11. Oboe head according to either claim 9 or claim 10, characterized in that it further includes trill holes (22).

12. Oboe according to claim 2, characterized in that the first body portion (10) carrying the octave holes (13) has a length from 100 to 120 mm.

13. Oboe according to claim 3, characterized in that the first body portion (10) carrying the octave holes (13) has a length from 100 to 120 mm.

14. Oboe according to claim 4, characterized in that the first body portion (10) carrying the octave holes (13) has a length from 100 to 120 mm.
